(19) United States
(12) Patent Application Publication
(10) Pub. No.: US 2003/0161466 A1
(43) Pub. Date: Aug. 28, 2003

(54) Call waiting and call progress signaling in a communication channel

(76) Inventors: Lee Begeja, Gillette, NJ (US); Melanie West, Evanston, IL (US)

Correspondence Address: Samuel H. Dworetsky, AT&T CORP., P.O. Box 4110, Middletown, NJ, 07748-4110, US

(21) Appl. No.: 09/904,618

(22) Filed: Jul. 13, 2001

(51) Int. Cl. H04M 3/42; H04M 3/00; H04M 1/00

(52) U.S. Cl. 379/418; 379/386; 379/215.01

(57) ABSTRACT

A method and apparatus are described for using a series of signals that create an illusion of a continuous ascending or descending series of pitches as call waiting or call progress or process progress signals. In a preferred embodiment, a condition appropriate for representation by a call waiting or call progress or process progress signal is detected and, in response thereto, a series of signals is generated that creates an illusion of a continuous ascending or descending series of pitches. Preferably, the series of signals is Shepard's tones and the tones are generated by generating a plurality of tones, or partials, at octave intervals, amplitude filtering the partials to produce an amplitude envelope that peaks near the centermost partial or partials, and shifting the partials upwards (or downwards) through the octave in steps that are a fraction of an octave and preferably are a semitone. Illustrative apparatus for practicing the invention comprises a detector for detecting a condition suitable for representation by a call waiting or call progress or process progress signal and a signal generator for generating Shepard's tones. Preferably, the signal generator is a digital signal processor.

### BACKGROUND OF THE INVENTION

This invention relates to call waiting and call progress signaling in a communication channel.

Numerous signals are provided to the caller in the course of a telephone call. The most familiar of these are the call progress signals, dial tone, line busy and ringback or audible ringing. A description of these and other call progress signals is set forth in ANSI TI.401 Appendix D 1988 as follows:

ANSI T1.401 Appendix D 1988

| Name | Frequency (Hz) | Pattern |
|---|---|---|
| Dial tone | 350 + 440 | Steady on |
| Message Waiting | 350 + 440 | 10 bursts (0.1 sec on, 0.1 sec off) |
| | | then steady on |
| Recall dial tone/ | 350 + 440 | 3 bursts (0.1 sec on, 0.1 sec off) then |
| confirmation tone | | steady on |
| Line busy | 480 + 620 | 0.5 sec on, 0.5 sec off, repeating |
| Reorder | 480 + 620 | 0.25 sec on, 0.25 sec off, repeating |
| Audible Ringing | 440 + 480 | 2 sec on, 4 set off, repeating |

Call waiting signals are also available to both the calling party and the called party. Typically, such signals are perceived as a click or a beep that is caused by interrupting the line current. Such a signal is sometimes provided to the calling party as an assurance that communication has not been lost while that party waits for the call to be completed. In other cases, music or aural announcements, typically about how important the call is to the called party, serve the same function. Call waiting signals are also provided to the called party when that party is communicating with a third party to indicate that another caller is waiting.

Developments in call waiting signaling have attempted to provide more information to the called party. For example, different types of call waiting signals can be used to signify different callers. Thus, in the case where phones are connected through a PBX, a single click on the line might indicate an incoming call from a phone served by the PBX while a double click on the line would indicate an incoming call from a source external to the PBX-served network. More recently, a service has been offered that uses Caller ID to identify the incoming caller and then provides to the called party an aural announcement that there is a call waiting from the party identified by Caller ID. This announcement is made only to the called party and cannot be heard by the third party with whom he or she is communicating. Similarly, in the case where the call is a data communication, call waiting announcements can be made in the form of a pop-up message on the display screen of the called party's computer terminal.

Despite these developments in call waiting and call progress signaling, there remains considerable room for further improvement. One area for improvement is in the psychology of such signaling.

In addition to telephone calls on the public switched telephone network (PSTN) or on private networks, there are numerous other situations where call waiting and call progress signaling are or can be used. These include, for example, wireless communication networks where there are often extensive delays in establishing a communication link between the calling and the called party and in user interfaces, especially those with no visual interface or only a limited visual interface. In addition to conventional telephone handsets and wireless handsets, examples of devices with limited visual interfaces include personal digital assistants (PDAs), wireless Internet devices, Internet appliances (including but not limited to Internet browsers), refrigerators, thermostats, washers, dryers and virtually any device that has an operation in progress. In addition, call waiting or call progress signaling could be applied to computer applications intended for the visually handicapped. In those circumstances, such signaling could be used to indicate the progress of an ongoing process.

### SUMMARY OF THE INVENTION

We have devised a method and apparatus for call waiting or call progress or process progress signaling that replaces conventional call waiting or call progress or process progress signals with a series of signals that create an illusion of a continuous ascending or descending series of pitches. One such series of signals that create this illusion is Shepard's tones. See, R. N. Shepard, “Circularity in Judgments of Relative Pitch,” J. Acoustical Society of America, Vol. 36, pp. 2346-2353 (1964), which is incorporated herein by reference. The use of such a series of tones avoids the monotony of conventional call waiting clicks and beeps and/or music or phone messages one does not want to hear and, in providing an illusion of a continuous change in pitch, creates an impression of progress.

In a preferred embodiment, the method of the invention is practiced by detecting on a communication line a condition appropriate for representation by a call waiting or call progress signal and, in response thereto, generating as a call waiting or call progress signal a series of signals that create an illusion of a continuous ascending or descending series of pitches. Preferably, the series of signals is Shepard's tones and the tones are generated by generating a plurality of tones, or partials, at octave intervals, amplitude filtering the partials to produce an amplitude envelope that peaks near the centermost partial or partials, and shifting the partials upwards (or downwards) through the octave in steps that are a fraction of an octave and preferably are a semitone.

Illustrative apparatus for practicing the invention comprises a detector for detecting a condition suitable for representation by a call waiting or call progress signal and a signal generator for generating Shepard's tones. Preferably, the signal generator is a digital signal processor.

### BRIEF DESCRIPTION OF DRAWINGS

These and other objects, features and advantages of the invention will be more readily apparent from the following detailed description of the invention in which:

FIG. 1 is a plot of frequency versus amplitude or intensity that is useful in understanding Shepard's tones;

FIG. 2 is a flowchart depicting a preferred embodiment of the invention; and

FIG. 3 is a block diagram of a preferred embodiment of the invention.

### DETAILED DESCRIPTION OF PREFERRED EMBODIMENT

The invention is preferably practiced using Shepard's tones and will be described in that context. However, other sets of tones are known that create the illusion of a continuous ascending or descending series of pitches; and it will be understood that the invention may also be practiced using such tones.

In addition to Shepard's work cited above, work in this area includes: E. M. Burns, “Circularity in Relative Pitch Judgments for Inharmonic Complex Tones: The Shepard Demonstration Revisited, Again,” Perception and Psychophysics, Vol. 30, pp. 467-472 (1981); M. R. Schroeder, “Auditory Paradox Based on Fractal Waveforms,” J. Acoustical Society of America, Vol. 79, pp. 186-189 (1986); Y. Nakajima et al., “Dynamic Pitch Perception for Complex Tones of Periodic Spectral Patterns,” Music Perception, Vol. 8, pp. 291-314 (1991); each of which is incorporated by reference herein.

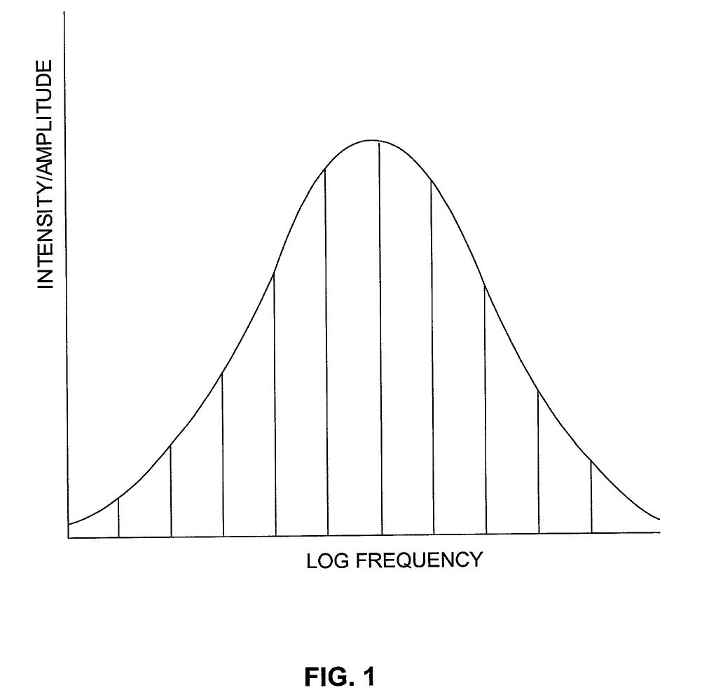

Shepard's tones comprise a plurality of tones, typically 10 in number, that are separated by octave intervals. The component tones may be referred to as partials. The amplitude of the centermost partial is greatest with the amplitudes of the other partials tapering off symmetrically about the center. As a result, the amplitude envelope has a Gaussian or half-sinusoidal profile as shown in FIG. 1.

The illusion of continuously ascending (or descending) pitch is created by generating a series of such tones in which the partials are successively shifted upwards (or downwards) by a fraction of an octave in each step. Typically, the size of this shift is a semitone, which represents about 6% of an octave; and as a result there are 12 notes in the typical Shepard's scale. These are the same 12 notes found in a piano octave.

While the partials are shifted, the amplitude envelope is held substantially constant. As a result, in the case where the partials are shifted upwards in increments of a semitone, the overall perception of the tones should likewise increase upwards by a semitone with each step. But because the amplitude envelope remains substantially constant, the amplitude of the higher frequency partials is decreased while the amplitude of the lower frequency partials increases. The average spectral content consequently remains substantially the same. And when the process of shifting the partials upwards by a semitone reaches the end of an octave, the process simply repeats itself from the lower end of the octave. However, since each successive set of partials is a semitone higher, the illusion is created that the tones are always increasing.

In accordance with the invention, Shepard's tones are used in place of conventional call waiting or call progress signals in any application where such signals might be used.

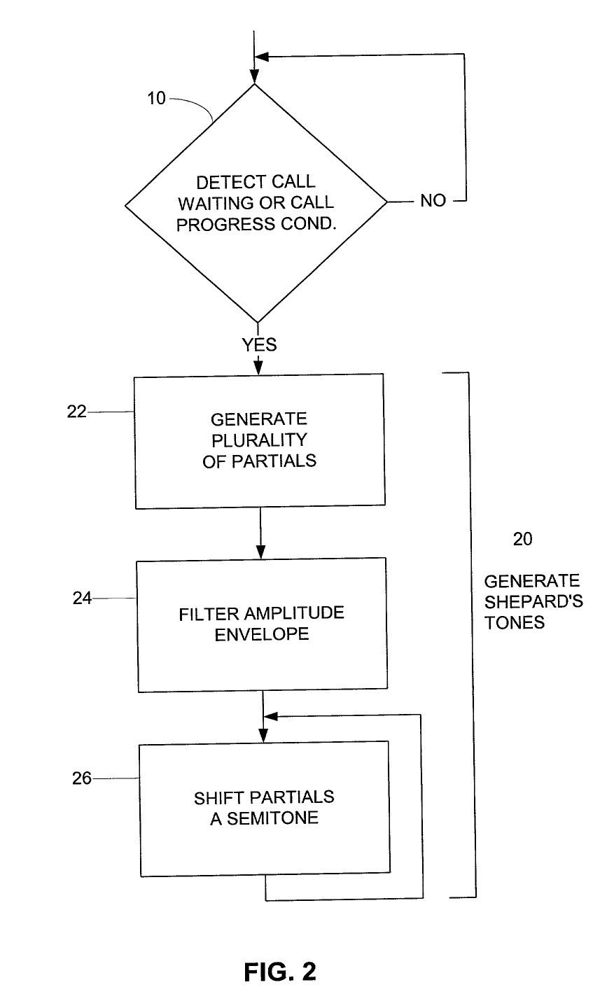

A preferred embodiment of the method of the invention is shown in the flowchart of FIG. 2. At step 10 a communication line is monitored to detect a condition appropriate for representation by a call waiting or call progress signal. Such a condition might be a call waiting signal transmitted from the central office of the called party or it might be the absence of any signal on the communication link for a pre-determined duration such as fifteen seconds. If such condition is detected, then at step 20 Shepard's tones are generated as the call waiting or call progress signal. Preferably, as shown in FIG. 2, Shepard's tones are generated by generating, at step 22, a plurality of tones, or partials, at octave intervals, amplitude filtering the partials at step 24 to produce an amplitude envelope that peaks near the centermost partial or partials, and shifting the partials at step 26 upwards (or downwards) through the octave in steps that are a fraction of an octave and preferably are a semitone.

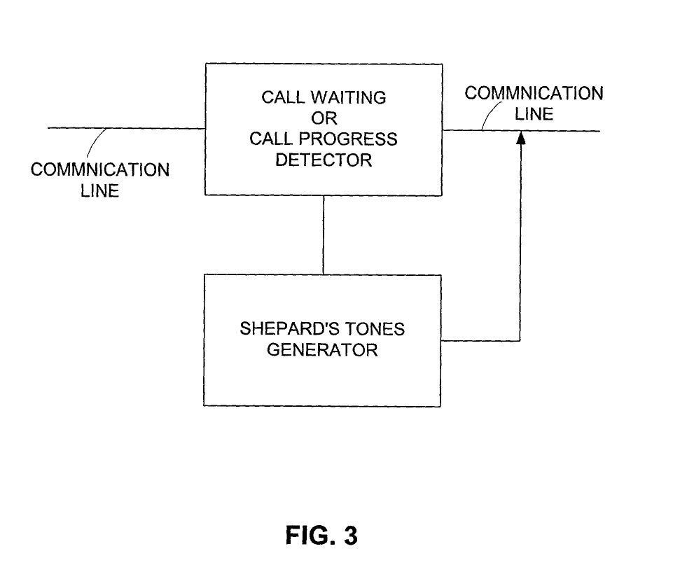

Illustrative apparatus for practicing the invention is shown in FIG. 3 and comprises a detector 50 for detecting a condition on a communication channel that is suitable for representation by a call waiting or call progress signal and a signal generator 60 for generating Shepard's tones upon detecting such a condition. The signal generator includes the capability of generating a plurality of tones, or partials, each an octave apart, filtering the amplitudes of the partials to produce an amplitude envelope that peaks near the frequency of the centermost partial or partials, and shifting the partials upwards (or downwards) through an octave in steps that are a fraction of an octave and preferably are a semitone while maintaining the amplitude envelope substantially constant. Preferably, the signal generator is a digital signal processor.

In some implementations of the invention, detector 50 and signal generator 60 can both be implemented on the same digital signal processor. In other applications such as those using the public switched telephone network (PSTN), it may be advantageous to locate detector 50 at some point in the PSTN—for example, at a central office—while signal generator 60 is located in equipment such as a telephone handset on a customer's premises.

While the invention has been described for the specific example of Shepard's tones having 10 partials, it will be appreciated that the invention may be practiced using any set of tones that produce the illusion of continuous ascending or descending tones. Further, while 10 partials are used in the conventional Shepard's tones, experiments have been reported in which the illusion of ascending or descending tones is created with as few as three partials. Likewise, the particular shape of the amplitude envelope is not critical as long as it tapers off from a maximum amplitude near the centermost partial or partials. Numerous other variations in the practice of the invention will be evident.

It should also be noted that the invention may also be practiced in a variety of different contexts wherever it is desired to provide an aural signal having the illusion of a continuously ascending (or descending) pitch. In addition to applications in wired and wireless telephony, applications of particular interest include usage in products such as PDAs that have limited visual interfaces, wireless Internet devices, Internet appliances (including but not limited to Internet browsers), refrigerators, thermostats, washers, dryers and virtually any device that has an operation in progress. In addition, this type of progress tone could be applied to and interfaces for the visually handicapped.

Thus, the signaling of the present invention could be used to show the progress of any process that was not continuing in an obvious manner. As an example, the wireless Internet allows a properly equipped cell phone or PDA to make shopping, auction, banking or stock transactions. Due to the nature of the current state of the wireless Internet, there can be delays of 30 seconds or more during which the system is working to complete the next step of the transaction. A user of the system, who is accustomed to the unreliable nature of wireless technology, could think that the transaction has been improperly terminated. Using the small screen of the cell phone to show progress is difficult, especially if the interface for the user uses speech recognition, since in that case the user is not even looking at the screen. A tone to indicate ongoing progress provides a valuable user interface function in this type of application. The use of a tone that sounds as though it is continuously rising provides a unique method for indicating the progress of the process or call.

Future appliances in the home are expected to have the ability to connect to the Internet to report problems and to adjust electric or gas rates. The homeowner might want to interact with the gas company through the device and the limited screen on the appliance would be aided by an audio interface that would inform the homeowner that the request is progressing.

To be truly useful and effective, the audio interface would have to get feedback on the continuity of the process; and the preferred embodiment of the invention includes means for getting this feedback by monitoring the relevant process. However, even if there was no such information from the source of the transaction or process, in the absence of any change in the state of the communication line, there could be a benefit to indicating that progress was being made in the system.

What is claimed is:

1. A method for generating progress signals comprising the steps of:
detecting a condition appropriate for representation by a progress signal; and in response thereto
generating as a progress signal a series of signals that create an illusion of a continuous ascending or descending series of pitches.

2. The method of claim 1 wherein the series of signals is Shepard's tones.

3. The method of claim 1 wherein the step of generating a series of signals comprises the steps of:
generating a plurality of tones each of which has a frequency separated from the others by an integer number of octaves; and
repeating said generating step a plurality of times with the frequencies of said tones being increased each time by a constant fraction of an octave; or
repeating said generating step a plurality of times with the frequencies of said tones being decreased each time by a fraction of an octave.

4. The method of claim 3 wherein the fraction of an octave is a semitone.

5. The method of claim 3 wherein the tones have an amplitude envelope that remains substantially constant as the generating step is repeated.

6. A method for generating call waiting or call progress or process progress signals on a communication channel comprising the steps of:
detecting a condition appropriate for representation by a call waiting or call progress signal; and in response thereto
generating as a call waiting or call progress or process progress signal a series of signals that create an illusion of a continuous ascending or descending series of pitches.

7. The method of claim 6 wherein the series of signals is Shepard's tones.

8. The method of claim 6 wherein the step of generating a series of signals comprises the steps of:
generating a plurality of tones each of which has a frequency separated from the others by an integer number of octaves; and
repeating said generating step a plurality of times with the frequencies of said tones being increased each time by a constant fraction of an octave; or
repeating said generating step a plurality of times with the frequencies of said tones being decreased each time by a fraction of an octave.

9. The method of claim 8 wherein the fraction of an octave is a semitone.

10. The method of claim 8 wherein the tones have an amplitude envelope that remains substantially constant as the generating step is repeated.

11. The method of claim 6 wherein the generating step is performed on customer equipment.

12. The method of claim 6 wherein the generating step is performed on telephone company equipment.

13. Apparatus for generating call waiting or call progress or process progress signals on a communication channel comprising:
a detector for detecting a condition appropriate for representation by a call waiting or call progress or process progress signal; and
a signal generator responsive to said detector for generating a series of signals that create an illusion of a continuous ascending or descending series of pitches.

14. The apparatus of claim 13 wherein the series of signals is Shepard's tones.

15. The apparatus of claim 13 wherein the signal generator is located on customer equipment.

16. The apparatus of claim 13 wherein the signal generator is located on telephone company equipment.

17. Apparatus for generating call waiting or call progress or process progress signals on a communication channel comprising:
means for detecting a condition appropriate for representation by a call waiting or call progress or process progress signal; and
means responsive to detection of said condition for generating a series of signals that create an illusion of a continuous ascending or descending series of pitches.

18. The apparatus of claim 17 wherein the series of signals is Shepard's tones.
